(19) United States
(12) Patent Application Publication
(10) Pub. No.: US 2023/0247621 A1
(43) Pub. Date: Aug. 3, 2023

(54) RADIO COMMUNICATION SYSTEM, CONTROL METHOD AND CONTROL DEVICE FOR RADIO COMMUNICATION SYSTEM, AND RADIO COMMUNICATION SYSTEM CONTROL PROGRAM

(71) Applicant: NIPPON TELEGRAPH AND TELEPHONE CORPORATION, Tokyo (JP)

(72) Inventors: Daisuke MURAYAMA, Musashino-shi, Tokyo (JP); Kenichi KAWAMURA, Musashino-shi, Tokyo (JP)

(73) Assignee: NIPPON TELEGRAPH AND TELEPHONE CORPORATION, Tokyo (JP)

(21) Appl. No.: 18/009,762

(22) PCT Filed: Jun. 15, 2020
(86) PCT No.: PCT/JP2020/023434

§ 371 Date: Dec. 12, 2022

(51) Int. Cl. H04W 72/1263

(52) U.S. Cl. CPC H04W 72/1263

(57) ABSTRACT

A specific signal in a radio communication system includes at least one of a synchronization signal and a reference signal. A first radio communication system performing radio communication in a first cell uses a first resource mapping pattern as a resource mapping pattern of the specific signal. A second radio communication system performing radio communication in a second cell that is adjacent to the first cell uses a second resource mapping pattern as a resource mapping pattern of the specific signal. The first resource mapping pattern and the second resource mapping pattern are set so as not to overlap with each other through resource mapping pattern control.

### TECHNICAL FIELD

The present disclosure relates to a technique for controlling a radio communication system. In particular, the present disclosure relates to a technique for controlling a specific signal such as a synchronization signal and a reference signal used in a radio communication system.

### BACKGROUND ART

NPL 1 discloses a physical layer specification of a new radio (NR) that is a radio communication scheme of a 5th generation mobile communication system (5G). In the NR, various reference signals are defined and mapped to radio resource (RE) separately from a payload of data/control signals. A plurality of “resource mapping patterns” which are patterns of the mapping position of the reference signal are defined. The same applies to a synchronization signal used for initial access.

A specific signal such as the synchronization signal and the reference signal is a sequence signal generated based on a seed. For example, the seed includes a cell ID. For example, the specific signal is a quasi-orthogonal M-sequence generated based on the seed including the cell ID.

In recent years, local 5G (L5G) in which a party other than telecommunications carriers locally constructs and operates its own 5G system has been proposed. For example, a business operator having a plant may operate its own 5G system in the plant premises. For frequency sharing, it is important to study radio wave interference between L5G systems whose cells are adjacent to each other.

### CITATION LIST

### Non Patent Literature

NPL 1: Takeda et al., “NR Physical Layer Specifications in 5G,” NTT DOCOMO Technical Journal, Vol. 26, No. 3, pp. 47 to 58, November 2018

### SUMMARY OF THE INVENTION

### Technical Problem

Two radio communication systems respectively performing radio communications in adjacent cells are considered. There is a possibility that radio wave interference occurs mutually or unilaterally between the two adjacent radio communication systems. In such a situation, a case where a resource mapping pattern of a specific signal such as a synchronization signal and a reference signal is identical between the adjacent radio communication systems is considered. In that case, there is a possibility that respective specific signals of the adjacent radio communication systems collide and thus the specific signals are hard to separate from each other. Degradation of the specific signal leads to degradation of communication quality.

An object of the present disclosure is to provide a technique capable of preventing collision of respective specific signals (at least one of synchronization signals and reference signals) of adjacent radio communication systems to suppress degradation of communication quality.

### Means for Solving the Problem

A first aspect relates to a radio communication system that performs radio communication in a first cell.

The radio communication system includes:
a base station configured to use a first resource mapping pattern as a resource mapping pattern of a specific signal including at least one of a synchronization signal and a reference signal to perform the radio communication; and
a control device configured to set the first resource mapping pattern.
In a second cell that is adjacent to the first cell, a second radio communication system is configured to use a second resource mapping pattern as a resource mapping pattern of the specific signal to perform radio communication.
The control device is configured to set the first resource mapping pattern so as not to overlap with the second resource mapping pattern.

A second aspect relates to a control method for a radio communication system.

In a first cell, a first radio communication system is configured to use a first resource mapping pattern as a resource mapping pattern of a specific signal including at least one of a synchronization signal and a reference signal to perform radio communication
In a second cell that is adjacent to the first cell, a second radio communication system is configured to use a second resource mapping pattern as a resource mapping pattern of the specific signal to perform radio communication.
The control method for the radio communication system includes a process of setting the first resource mapping pattern and the second resource mapping pattern so as not to overlap with each other.

A third aspect relates to a control device for a radio communication system.

In a first cell, the radio communication system is configured to use a first resource mapping pattern as a resource mapping pattern of a specific signal including at least one of a synchronization signal and a reference signal to perform radio communication.
In a second cell that is adjacent to the first cell, a second radio communication system is configured to use a second resource mapping pattern as a resource mapping pattern of the specific signal to perform radio communication.
The control device for the radio communication system is configured to set the first resource mapping pattern so as not to overlap with the second resource mapping pattern.

A fourth aspect relates to a radio communication system control program. The radio communication system control program is executed by a computer and causes the computer to operate as the above-described control device. The radio communication system control program may be recorded on a non-transitory computer-readable recording medium. The radio communication system control program may be provided via a network.

### Effects of the Invention

In the first cell, the first resource mapping pattern is used as the resource mapping pattern of the specific signal. In the second cell that is adjacent to the first cell, the second resource mapping pattern is used as the resource mapping pattern of the specific signal. The first resource mapping pattern and the second resource mapping pattern are set so as not to overlap with each other. It is thus possible to prevent collision of the respective specific signals of the adjacent radio communication systems and to separate the specific signals from each other. As a result, degradation of communication quality is suppressed.

### BRIEF DESCRIPTION OF DRAWINGS

FIG. 1 is a conceptual diagram for explaining an overview of a plurality of radio communication systems according to an embodiment of the present disclosure.

FIG. 2 is a conceptual diagram showing an example of a resource mapping pattern of a reference signal.

FIG. 3 is a conceptual diagram for explaining resource mapping pattern control according to an embodiment of the present disclosure.

FIG. 4 is a conceptual diagram for explaining a configuration example of a radio communication system according to an embodiment of the present disclosure.

FIG. 5 is a block diagram showing a functional configuration example of a radio communication system according to an embodiment of the present disclosure.

FIG. 6 is a block diagram showing a configuration example of a control device for a radio communication system according to an embodiment of the present disclosure.

FIG. 7 is a flowchart showing processing performed by a radio communication system according to an embodiment of the present disclosure.

FIG. 8 is a flowchart showing a first example of resource mapping pattern control (Step S100) according to an embodiment of the present disclosure.

FIG. 9 is a flowchart showing a second example of resource mapping pattern control (Step S100) according to an embodiment of the present disclosure.

FIG. 10 is a flowchart showing a third example of resource mapping pattern control (Step S100) according to an embodiment of the present disclosure.

FIG. 11 is a flowchart showing a fourth example of resource mapping pattern control (Step S100) according to an embodiment of the present disclosure.

### DESCRIPTION OF EMBODIMENTS

Hereinafter, embodiments of the present disclosure will be described with reference to the attached drawings.

### 1. Overview

### 1-1. Radio Communication System

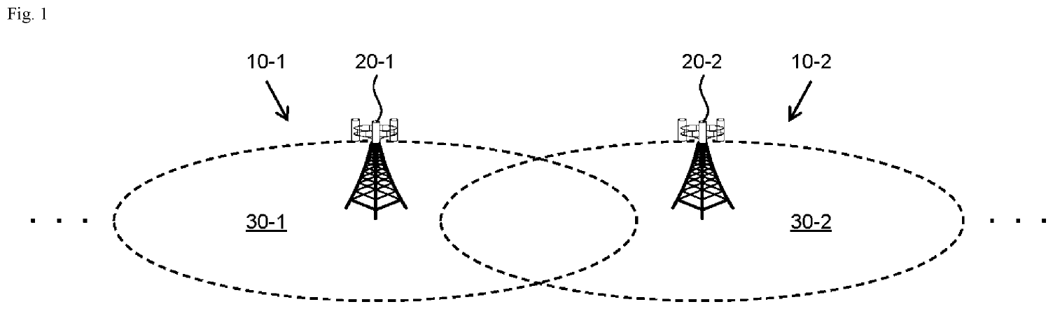

FIG. 1 is a conceptual diagram for explaining an overview of a plurality of radio communication systems 10 according to the present embodiment. Each radio communication system 10 includes a base station 20 and performs radio communication in a cell 30 around the base station 20.

FIG. 1 shows two adjacent radio communication systems 10-1 and 10-2 as representatives. The first radio communication system 10-1 includes a first base station 20-1 and performs radio communication in a first cell 30-1 around the first base station 20-1. The second radio communication system 10-2 includes a second base station 20-2 and performs radio communication in a second cell 30-2 around the second base station 20-2. The first cell 30-1 and the second cell 30-2 are adjacent to each other. Here, “the two cells being adjacent to each other” also includes a situation where the two cells partially overlap each other. Also, the first radio communication system 10-1 and the second radio communication system 10-2 share the same frequency band.

For example, the first radio communication system 10-1 and the second radio communication system 10-2 are local 5G (L5G) systems. The first radio communication system 10-1 and the second radio communication system 10-2 are operated in adjacent areas. For example, the first radio communication system 10-1 and the second radio communication system 10-2 are operated by different business operators.

### 1-2. Specific Signal (Synchronization Signal and Reference Signal)

Next, a synchronization signal and a reference signal used in the radio communication performed by the radio communication systems 10 are considered.

A synchronization signal (SS) is a known sequence signal used for an initial access. Examples of the synchronization signal include a primary synchronization signal (PSS) and a secondary synchronization signal (SSS). A user equipment (UE) detects the synchronization signal transmitted from the base station 20, performs synchronization with the base station, and establishes connection with the base station.

A reference signal (RS) also is a known sequence signal. For example, the reference signal is used by the user equipment or the base station 20 to perform channel estimation.

In the following description, the “specific signal” means at least one of the synchronization signal and the reference signal. The specific signal is a sequence signal generated based on a seed. For example, the seed includes a cell ID. For example, the specific signal is a quasi-orthogonal M-sequence generated based on the seed including the cell ID.

The specific signal is mapped to radio resource (RE). In other words, scheduling of the specific signal is performed. A pattern of a mapping position of the specific signal is hereinafter referred to as a “resource mapping pattern MP.”

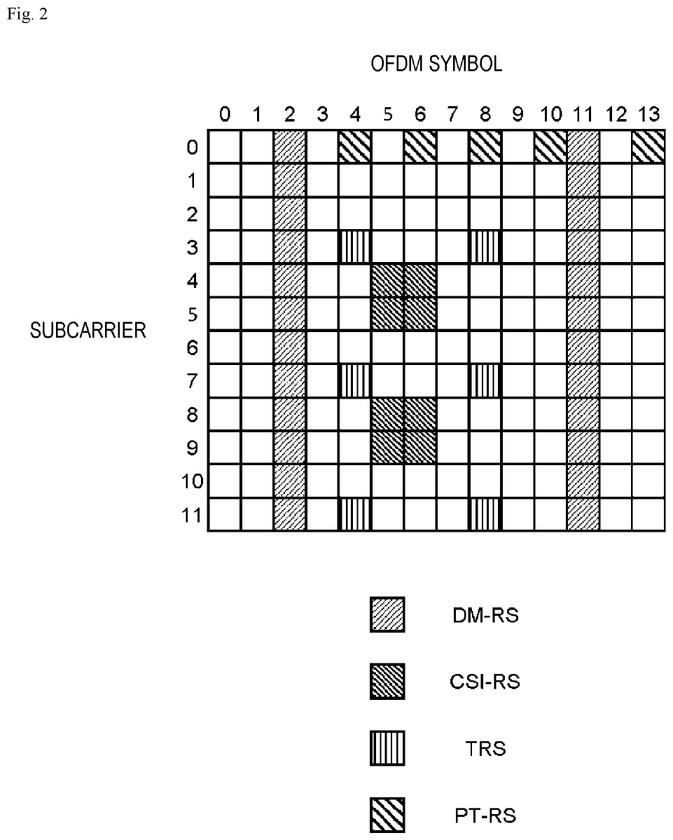

FIG. 2 shows an example of the resource mapping pattern of the reference signal in the new radio (NR) (see NPL 1). In the example shown in FIG. 2, one OFDM symbol is composed of twelve subcarriers, and one slot is composed of fourteen OFDM symbols. DM-RS (Demodulation RS) is a reference signal for data demodulation. CSI-RS (Channel State Information RS) is a reference signal for channel estimation. TRS (Tracking RS) is a reference signal for time/frequency tracking. PT-RS (Phase Tracking RS) is a reference signal for phase noise estimation.

### 1-3. Resource Mapping Pattern Control

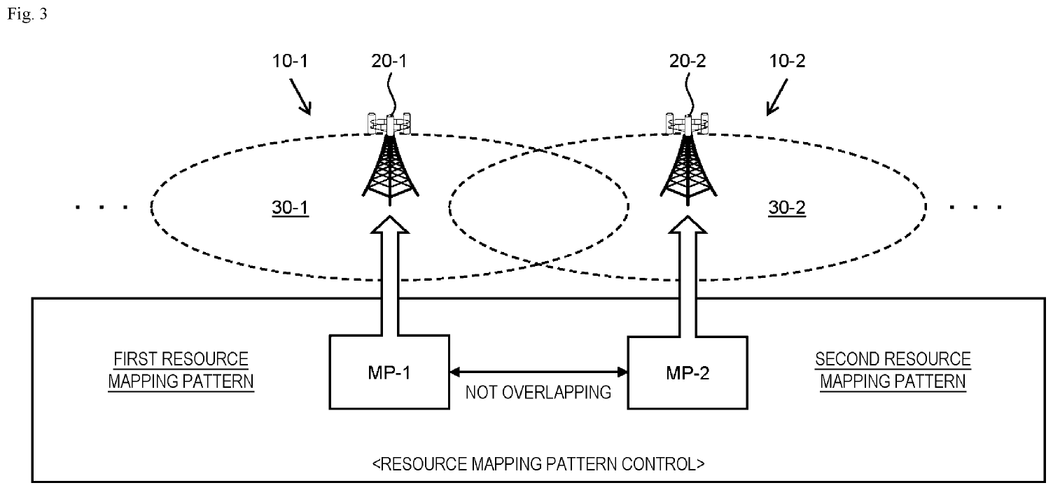

FIG. 3 is a conceptual diagram for explaining resource mapping pattern control according to the present embodiment. The first radio communication system 10-1 performs the radio communication by using a “first resource mapping pattern MP-1” as the resource mapping pattern MP of the specific signal. The second radio communication system 10-2 performs the radio communication by using a “second resource mapping pattern MP-2” as the resource mapping pattern MP of the specific signal.

First, a case in which the first resource mapping pattern MP-1 is identical to the second resource mapping pattern MP-2 will be considered as a comparative example. There is a possibility that radio wave interference occurs mutually or unilaterally between the first radio communication system 10-1 and the second radio communication system 10-2 that are adjacent to each other. Therefore, when the first resource mapping pattern MP-1 is identical to the second resource mapping pattern MP-2, there is a possibility that respective specific signals of the first radio communication system 10-1 and the second radio communication system 10-2 collide and thus the specific signals are hard to separate from each other. Degradation of the specific signal leads to degradation of communication quality.

For example, if the reference signals collide against each other and the signal degradation is caused, accuracy of the channel estimation or the like based on the reference signal is degraded. Also, if the synchronization signal for the initial access is degraded and a probability of detection of the synchronization signal decreases, a probability of the initial access decreases.

In view of the above, according to the present embodiment, “resource mapping pattern control” is performed in order to prevent the collision between the respective specific signals of the first radio communication system 10-1 and the second radio communication system 10-2. More specifically, the resource mapping pattern control sets the first resource mapping pattern MP-1 and the second resource mapping pattern MP-2 so as not to overlap with each other. Typically, a plurality of resource mapping pattern candidates MPS that do not overlap with each other are defined in advance. Then, the first resource mapping pattern MP-1 and the second resource mapping pattern MP-2 are selected not to overlap with each other from among the predetermined resource mapping pattern candidates MPS. In this manner, it is possible to prevent the collision of the respective specific signals of the first radio communication system 10-1 and the second radio communication system 10-2 and to separate the specific signals from each other. As a result, the degradation of communication quality is suppressed.

It can be also said that the resource mapping pattern control schedules the respective specific signals of the first radio communication system 10-1 and the second radio communication system 10-2 to be exclusive. Time synchronization between the first radio communication system 10-1 and the second radio communication system 10-2 is not essential. However, in order to efficiently achieve the exclusive scheduling of the specific signals, it may be desirable to match resource grids through the time synchronization.

The resource mapping pattern control is executed by at least one of the first radio communication system 10-1 and the second radio communication system 10-2. Both the first radio communication system 10-1 and the second radio communication system 10-2 may execute the resource mapping pattern control.

Various examples are conceivable as specific methods for the resource mapping pattern control. The various examples of the resource mapping pattern control will be described below.

### 1-4. Effects

As described above, the first radio communication system 10-1 that performs the radio communication in the first cell 30-1 uses the first resource mapping pattern MP-1 as the resource mapping pattern MP of the specific signal. The second radio communication system 10-2 that performs the radio communication in the second cell 30-2 adjacent to the first cell 30-1 uses the second resource mapping pattern MP-2 as the resource mapping pattern MP of the specific signal.

According to the present embodiment, the first resource mapping pattern MP-1 and the second resource mapping pattern MP-2 are set so as not to overlap with each other through the resource mapping pattern control. It is thus possible to prevent the collision of the respective specific signals of the first radio communication system 10-1 and the second radio communication system 10-2 and to separate the specific signals from each other. As a result, degradation of communication quality is suppressed.

The present embodiment is useful for the local 5G (L5G) system, for example.

### 2. Configuration Example of Radio Communication System

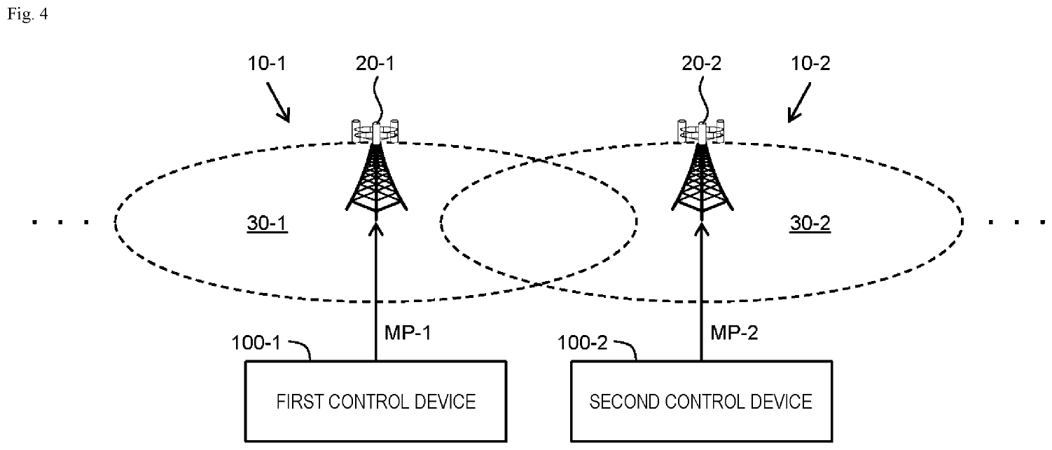

FIG. 4 is a conceptual diagram for explaining a configuration example of the radio communication system 10 according to the present embodiment. Each radio communication system 10 includes a control device 100 in addition to the base station 20.

The first radio communication system 10-1 includes a first control device 100-1 in addition to the first base station 20-1 that performs the radio communication in the first cell 30-1. The first control device 100-1 performs the resource mapping pattern control to set the first resource mapping pattern MP-1. The first base station 20-1 performs the radio communication by using the first resource mapping pattern MP-1 set by the first control device 100-1.

The second radio communication system 10-2 includes a second control device 100-2 in addition to the second base station 20-2 that performs the radio communication in the second cell 30-2. The second control device 100-2 performs the resource mapping pattern control to set the second resource mapping pattern MP-2. The second base station 20-2 performs the radio communication by using the second resource mapping pattern MP-2 set by the second control device 100-2.

A position and a connection configuration of the control device 100 are not limited in particular. The control device 100 may be included in a core unit or may be included in a base station control unit. The control device 100 may be disposed in the vicinity of the base station 20 or may be disposed at a position away from the base station 20 via a network. The control device 100 and the base station 20 are preferably connected in a wired manner. The control device 100 and the base station 20 may be connected in a radio manner.

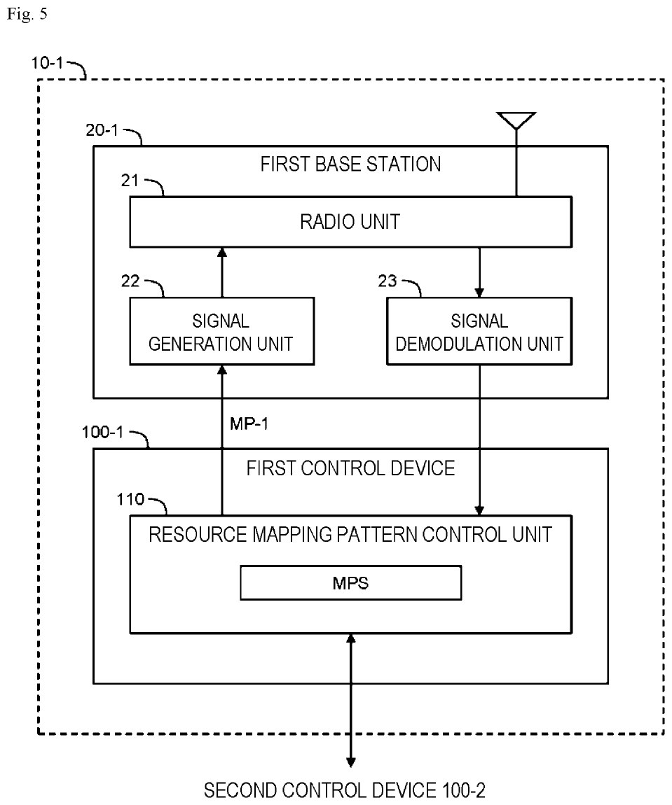

FIG. 5 is a block diagram showing a functional configuration example of the radio communication system 10 according to the present embodiment. As a representative, a functional configuration example of the first radio communication system 10-1 is shown in FIG. 5. The same applies to the second radio communication system 10-2.

The first base station 20-1 includes a radio unit 21, a signal generation unit 22, and a signal demodulation unit 23. The radio unit 21 transmits and receives radio signals.

The signal generation unit 22 generates a transmission signal. The transmission signal includes the specific signal such as the synchronization signal and the reference signal. The signal generation unit 22 generates the transmission signal including the specific signal that is mapped in accordance with the first resource mapping pattern MP-1. Then, the signal generation unit 22 outputs the transmission signal to the radio unit 21.

The signal demodulation unit 23 demodulates the radio signal received by the radio unit 21. The signal demodulation unit 23 transmits the received signal to the first control device 100-1 as necessary.

The first control device 100-1 includes a resource mapping pattern control unit 110 that executes the resource mapping pattern control. The resource mapping pattern control unit 110 holds a plurality of resource mapping pattern candidates MPS that do not overlap with each other. The plurality of resource mapping pattern candidates MPS are defined in advance. The resource mapping pattern control unit 110 determines the first resource mapping pattern MP-1 to be used from among the predetermined resource mapping pattern candidates MPS. Then, the resource mapping pattern control unit 110 notifies the signal generation unit 22 of the first base station 20-1 of the first resource mapping pattern MP-1. Various examples of the resource mapping pattern control will be described later.

The first control device 100-1 may communicate with the second control device 100-2. For example, the first control device 100-1 and the second control device 100-2 are connected to each other via a dedicated line. In another example, the first control device 100-1 and the second control device 100-2 may perform radio communication using integrated access and backhaul (IAB).

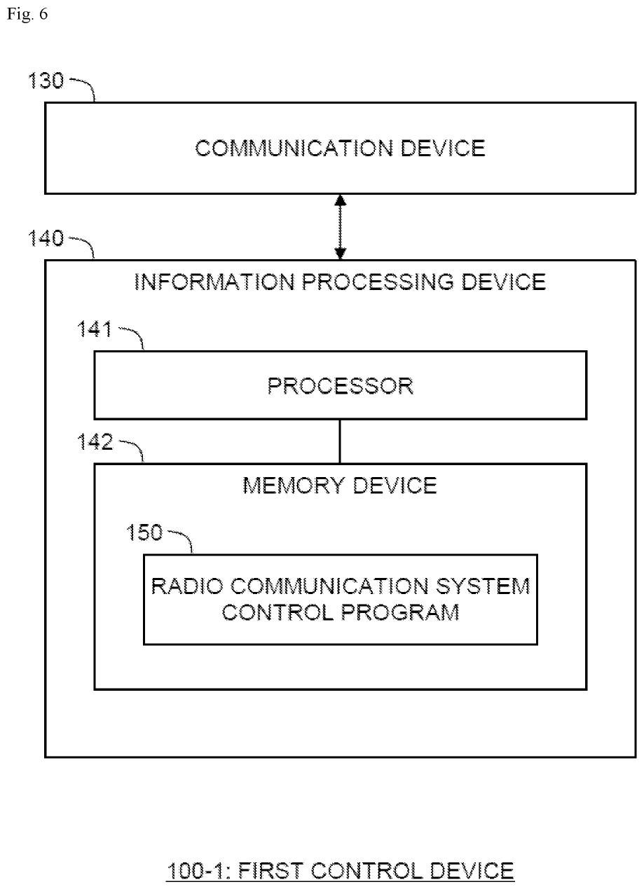

FIG. 6 is a block diagram showing a configuration example of the control device 100 according to the present embodiment. As a representative, a configuration example of the first control device 100-1 is shown in FIG. 6. The same applies to the second control device 100-2.

The first control device 100-1 includes a communication device 130 and an information processing device 140.

The communication device 130 communicates with the first base station 20-1. Moreover, the communication device 130 communicates with the second control device 100-2. As described above, the communication scheme may be a wired communication scheme or a radio communication scheme.

The information processing device 140 is a computer that executes a variety of information processing. For example, the information processing device 140 includes a processor 141 and a memory device 142. The processor 141 executes a variety of information processing. For example, the processor 141 includes a central processing unit (CPU). The memory device 142 stores a variety of information used for the processing executed by the processor 141. Examples of the memory device 142 include a volatile memory, a non-volatile memory, a hard disk drive (HDD), a solid state drive (SDD), and the like.

A radio communication system control program 150 is a computer program executed by a computer. Functions of the information processing device 140 are implemented by the processor 141 executing the radio communication system control program 150. The radio communication system control program 150 is stored in the memory device 142. The radio communication system control program 150 may be recorded on a non-transitory computer-readable recording medium. The radio communication system control program 150 may be provided via a network.

The information processing device 140 may be implemented by using hardware such as an application specific integrated circuit (ASIC), a programmable logic device (PLD), or a field programmable gate array (FPGA).

The aforementioned resource mapping pattern control unit 110 is implemented by the communication device 130 and the information processing device 140.

### 3. Processing Performed by Radio Communication System

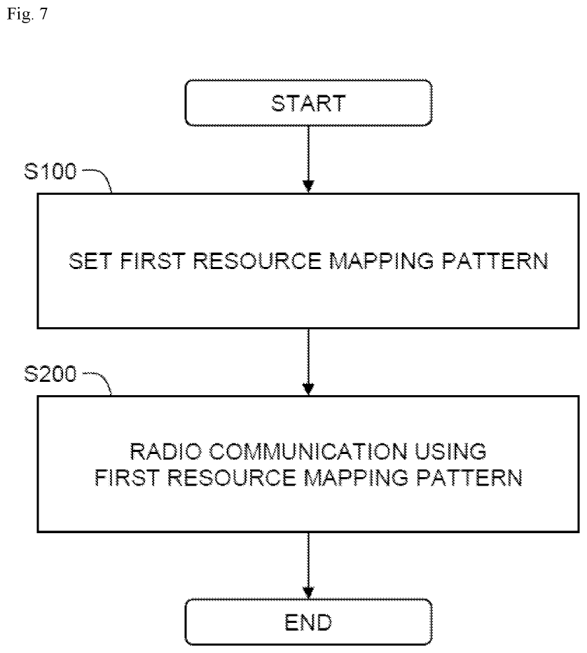

FIG. 7 is a flowchart showing processing performed by the radio communication system 10 according to the present embodiment. Here, processing performed by the first radio communication system 10-1 will be described as a representative. The same applies to the second radio communication system 10-2.

In Step S100, the resource mapping pattern control unit 110 of the first control device 100-1 performs the resource mapping pattern control. Specifically, the resource mapping pattern control unit 110 sets the first resource mapping pattern MP-1 so as not to overlap with the second resource mapping pattern MP-2. Then, the resource mapping pattern control unit 110 notifies the first base station 20-1 of the first resource mapping pattern MP-1.

In Step S200, the first base station 20-1 performs the radio communication. Specifically, the signal generation unit 22 generates the transmission signal including the specific signal by using the first resource mapping pattern MP-1. Then, the signal generation unit 22 outputs the transmission signal to the radio unit 21. The radio unit 21 transmits the transmission signal.

Hereinafter, various examples of the resource mapping pattern control (Step S100) will be described.

### 3-1. First Example

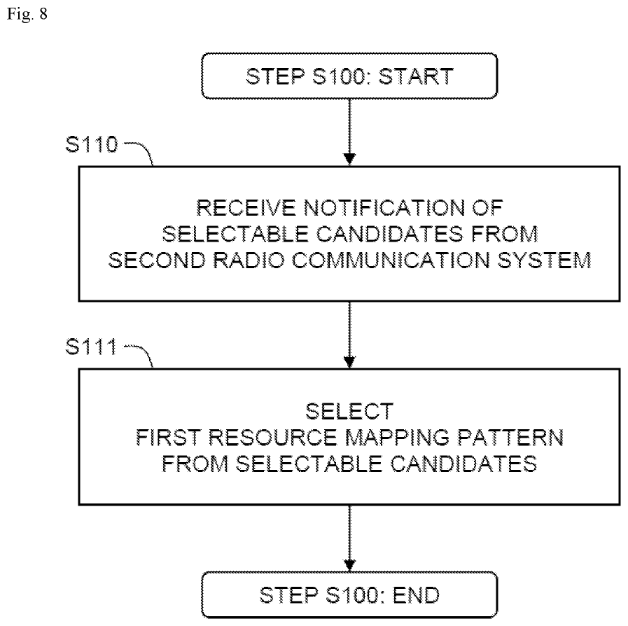

FIG. 8 is a flowchart showing a first example of the resource mapping pattern control (Step S100).

In Step S110, the resource mapping pattern control unit 110 receives a notification of “selectable candidates” from the second control device 100-2 of the second radio communication system 10-2. The selectable candidates include at least one resource mapping pattern candidate that does not overlap with the second resource mapping pattern MP-2.

For example, the second control device 100-2 holds the predetermined resource mapping pattern candidates MPS, as in the case of the first control device 100-1. The second control device 100-2 can generate the selectable candidates based on the second resource mapping pattern MP-2 in use and the predetermined resource mapping pattern candidates MPS. The second control device 100-2 may periodically notify the selectable candidates.

In Step S111, the resource mapping pattern control unit 110 selects the first resource mapping pattern MP-1 from among the received selectable candidates.

In this manner, it is possible to surely set the first resource mapping pattern MP-1 so as not to overlap with the second resource mapping pattern MP-2.

### 3-2. Second Example

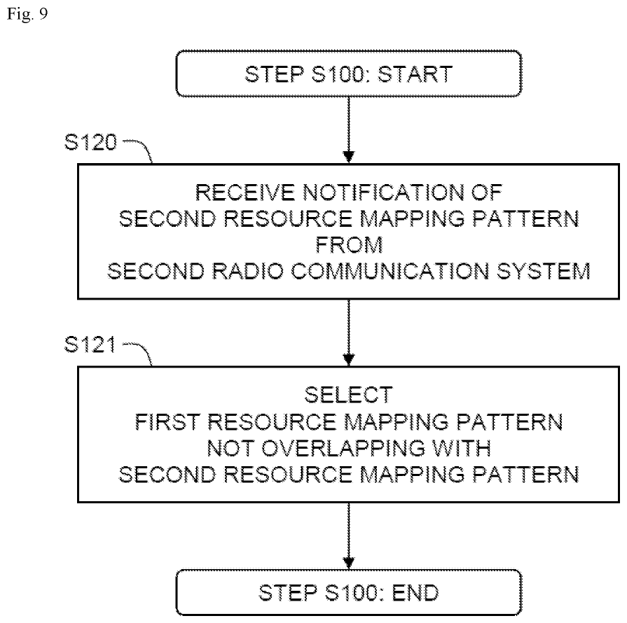

FIG. 9 is a flowchart showing a second example of the resource mapping pattern control (Step S100). The second example is a modification example of the first example.

In Step S120, the resource mapping pattern control unit 110 receives a notification of the “second resource mapping pattern MP-2” from the second control device 100-2 of the second radio communication system 10-2.

In Step S121, the resource mapping pattern control unit 110 selects the first resource mapping pattern MP-1 that does not overlap with the second resource mapping pattern MP-2 from among the predetermined resource mapping pattern candidates MPS.

In this manner, it is possible to surely set the first resource mapping pattern MP-1 so as not to overlap with the second resource mapping pattern MP-2.

### 3-3. Third Example

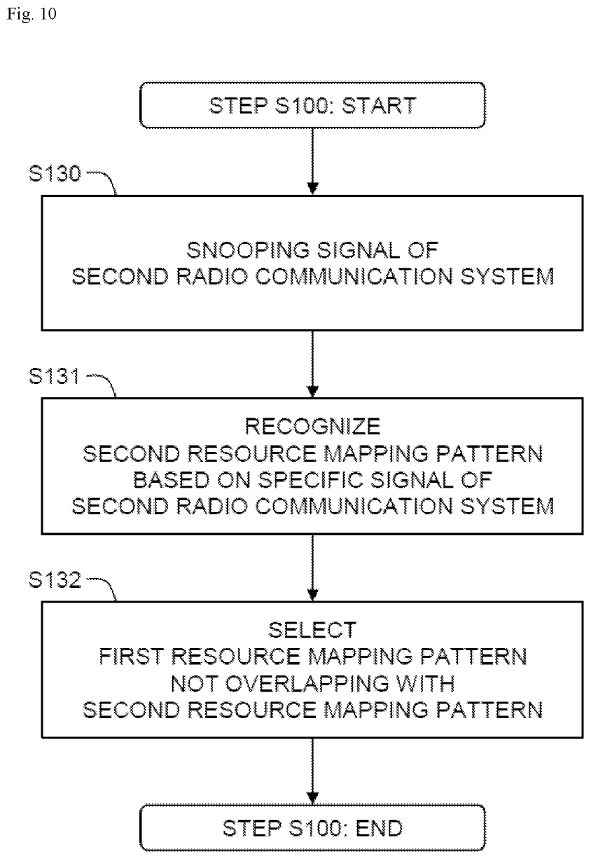

FIG. 10 is a flowchart showing a third example of the resource mapping pattern control (Step S100).

In Step S130, the first base station 20-1 receives (snoops) a signal transmitted from the second base station 20-2 of the second radio communication system 10-2. The signal demodulation unit 23 of the first base station 20-1 notifies the resource mapping pattern control unit 110 of the received signal. Alternatively, the signal demodulation unit 23 notifies the resource mapping pattern control unit 110 of the specific signal included in the received signal.

In Step S131, the resource mapping pattern control unit 110 recognizes the second resource mapping pattern MP-2 used in the second radio communication system 10-2, based on the specific signal included in the received signal.

In Step S132, the resource mapping pattern control unit 110 selects the first resource mapping pattern MP-1 that does not overlap the second resource mapping pattern MP-2 from among the predetermined resource mapping pattern candidates MPS.

According to the third example, the first control device 100-1 is able to set the first resource mapping pattern MP-1 by itself without receiving any notification from the second control device 100-2.

### 3-4. Fourth Example

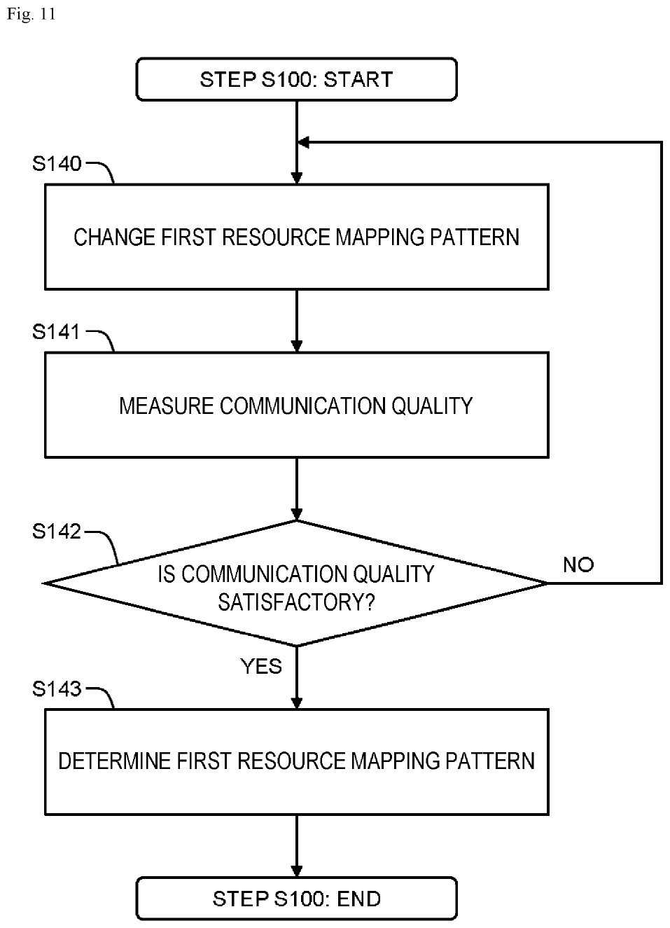

FIG. 11 is a flowchart showing a fourth example of the resource mapping pattern control (Step S100). The processing flow shown in FIG. 11 is periodically executed.

In Step S140, the resource mapping pattern control unit 110 changes the first resource mapping pattern MP-1 to be used. In other words, the resource mapping pattern control unit 110 selects one that is different from the previous one from among the predetermined resource mapping pattern candidates MPS.

In Step S141, the first base station 20-1 performs the radio communication by using the first resource mapping pattern MP-1 set in Step S140. Also, the first base station 20-1 measures and records communication quality. Examples of a parameter indicating the communication quality include a signal to interference power ratio (SIR) and the like. The first base station 20-1 notifies the resource mapping pattern control unit 110 of the communication quality.

In Step S142, the resource mapping pattern control unit 110 determines whether or not the communication quality is satisfactory. For example, the resource mapping pattern control unit 110 determines whether or not the communication quality is equal to or higher than a certain level. When the communication quality is lower than the certain level (Step S142; No), the processing returns back to Step S140. On the other hand, when the communication quality is equal to or higher than the certain level (Step S142l; Yes), the processing proceeds to Step S143.

In another example, the resource mapping pattern control unit 110 determines whether or not the communication quality is the top quality. When the communication quality is not the top quality (Step S142; No), the processing returns back to Step S140. On the other hand, when the communication quality is the top quality (Step S142; Yes), the processing proceeds to Step S143.

In Step S143, the resource mapping pattern control unit 110 determines the one selected in Step S140 as the first resource mapping pattern MP-1.

As described above, according to the fourth example, the first resource mapping pattern MP-1 is periodically switched between the predetermined resource mapping pattern candidates MPS. In other words, hopping of the first resource mapping pattern MP-1 is performed. Although there is a little possibility that the first resource mapping pattern MP-1 temporarily overlaps with the second resource mapping pattern MP-2, the first resource mapping pattern MP-1 does not overlap with the second resource mapping pattern MP-2 in general. In particular, the first resource mapping pattern MP-1 with the satisfactory communication quality is considered not to overlap with the second resource mapping pattern MP-2. Thus, the effects of the present embodiment can be obtained.

### REFERENCE SIGNS LIST

10 Radio communication system
10-1 First radio communication system
10-2 Second radio communication system
20 Base station
20-1 First base station
20-2 Second base station
21 Radio unit
22 Signal generation unit
23 Signal demodulation unit
30 Cell
30-1 First cell
30-2 Second cell
100 Control device
100-1 First control device
100-2 Second control device
110 Resource mapping pattern control unit
130 Communication device
140 Information processing device
141 Processor
142 Memory device
150 Radio communication system control program
MP-1 First resource mapping pattern
MP-2 Second resource mapping pattern

1. A radio communication system that performs radio communication in a first cell, the radio communication system comprising:
a base station configured to use a first resource mapping pattern as a resource mapping pattern of a specific signal including at least one of a synchronization signal and a reference signal to perform the radio communication; and
a control device configured to set the first resource mapping pattern, wherein
in a second cell that is adjacent to the first cell, a second radio communication system is configured to use a second resource mapping pattern as a resource mapping pattern of the specific signal to perform radio communication, and
the control device is configured to set the first resource mapping pattern so as not to overlap with the second resource mapping pattern.

2. The radio communication system according to claim 1, wherein
the control device is configured to:
receive a notification of at least one resource mapping pattern candidate that does not overlap with the second resource mapping pattern from the second radio communication system; and
select the first resource mapping pattern from the at least one resource mapping pattern candidate.

3. The radio communication system according to claim 1, wherein
the control device is configured to:
receive a notification of the second resource mapping pattern from the second radio communication system; and
select the first resource mapping pattern that does not overlap with the second resource mapping pattern from among predetermined resource mapping pattern candidates.

4. The radio communication system according to claim 1, wherein
the control device is configured to:
recognize the second resource mapping pattern based on the specific signal included in a signal transmitted from a base station of the second radio communication system; and
select the first resource mapping pattern that does not overlap with the second resource mapping pattern from among predetermined resource mapping pattern candidates.

5. The radio communication system according to claim 1, wherein
the control device is configured to periodically switch the first resource mapping pattern between predetermined resource mapping pattern candidates.

6. A control method for a radio communication system, wherein
in a first cell, a first radio communication system is configured to use a first resource mapping pattern as a resource mapping pattern of a specific signal including at least one of a synchronization signal and a reference signal to perform radio communication, and
in a second cell that is adjacent to the first cell, a second radio communication system is configured to use a second resource mapping pattern as a resource mapping pattern of the specific signal to perform radio communication,
the control method comprising a process of setting the first resource mapping pattern and the second resource mapping pattern so as not to overlap with each other.

7. A control device for a radio communication system, wherein
in a first cell, the radio communication system is configured to use a first resource mapping pattern as a resource mapping pattern of a specific signal including at least one of a synchronization signal and a reference signal to perform radio communication, and
in a second cell that is adjacent to the first cell, a second radio communication system is configured to use a second resource mapping pattern as a resource mapping pattern of the specific signal to perform radio communication,
the control device being configured to set the first resource mapping pattern so as not to overlap with the second resource mapping pattern.

8. (canceled)
